(19) United States
(12) Patent Application Publication
(10) Pub. No.: US 2007/0158190 A1
(43) Pub. Date: Jul. 12, 2007

(54) PH meter and sensor thereof

(75) Inventors: Jung-Chuan Chou, Yunlin County (TW); Wen-Bin Hong, Nantou County (TW)

Correspondence Address: BIRCH STEWART KOLASCH & BIRCH, PO BOX 747, FALLS CHURCH, VA, 22040-0747, US

(73) Assignee: National Yunlin University of Science and Technology

(21) Appl. No.: 11/451,426

(22) Filed: Jun. 13, 2006

(30) Foreign Application Priority Data
Jan. 11, 2006 (TW) 095101024

(51) Int. Cl. G01N 27/26

(52) U.S. Cl. 204/416

(57) ABSTRACT

A pH sensor is disclosed, including conductive glass, a SnO₂ film formed on the conductive glass, and a field effect transistor (FET) with a gate coupled to the SnO₂ film. When the SnO₂ film contacts a liquid with a predetermined voltage, voltage between the liquid and the SnO₂ film varies according to pH of the liquid, thereby changing channel current of the FET. The pH of the liquid can thus be determined according to the channel current.

### BACKGROUND OF THE INVENTION

1. Field of the Invention

The invention relates to chemical analysis and more particularly to a device measuring pH of liquids.

2. Description of the Related Art

In 1970, P. Bergveld proposed Ion-sensitive field effect transistor (ISFET). In this proposal, the metallic gate of a metal-oxide-semiconductor field effect transistor (MOSFET) is removed and replaced with a sensing film. The FET is then immersed in electrolyte. The sensing film produces different potentials at the interface with the electrolyte, changing electric current in the channel of the FET. The pH of the electrolyte is thus measured.

Additionally, J. V. D Spiegel et al. proposed extended gate field effect transistor (EGFET) structure. A sensing film is disposed on a signal terminal extending from the gate of the FET. As such, only the sensing film requires immersion in the environment for measurement, rather than the entire FET.

### BRIEF SUMMARY OF THE INVENTION

The invention provides a pH sensor, comprising conductive glass, a SnO₂ film formed on the conductive glass, and a field effect transistor with a gate coupled to the SnO₂ film. The SnO₂ film contacts a liquid with a predetermined voltage, generating a voltage difference between the liquid and the SnO₂ film. The pH sensor thus determines the pH of the liquid according to a linear relationship between channel current of the field effect transistor and the voltage difference.

The invention further provides a chemical sensing platform for measuring pH a liquid, comprising a reference electrode, to be placed in the liquid to provide a stable voltage, and at least one pH sensor, comprising conductive glass, a SnO₂ film formed on the conductive glass, and a field effect transistor with a gate coupled to the SnO₂ film. The SnO₂ film contacts a liquid with a predetermined voltage, generating a voltage difference between the liquid and the SnO₂ film. The pH sensor thus determines the pH of the liquid according to a linear relationship between channel current of the field effect transistor and the voltage difference.

### BRIEF DESCRIPTION OF THE DRAWINGS

The invention can be more fully understood by reading the subsequent detailed description and examples with references made to the accompanying drawings, wherein:

FIG. 1 is an architectural diagram of a chemical sensing platform in accordance with an embodiment of the invention;

FIG. 2 is a schematic diagram of a sensing and amplification device in accordance with an embodiment of the invention; and

FIG. 3 shows response relation of a sensing and amplification of FIG. 2 with temperature of a liquid.

### DETAILED DESCRIPTION OF THE INVENTION

The invention replaces a metal gate of an ion sensing field effect transistor with a SnO₂ film to provide a readout device for pH sensing. Channel current of the ion sensing field effect transistor has a linear relationship with pH of a liquid contacting the SnO₂ film.

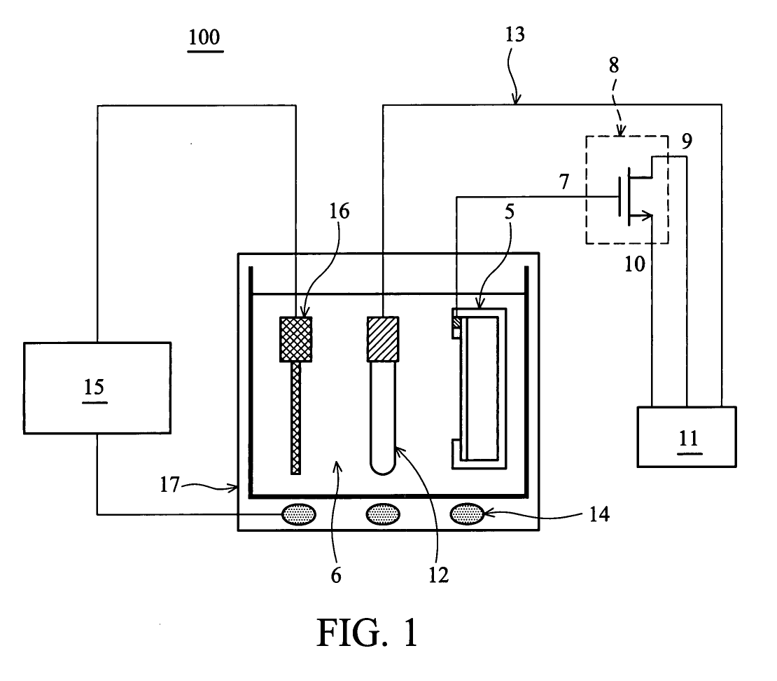

FIG. 1 is an architectural diagram of a chemical sensing platform 100 in accordance with an embodiment of the invention. In the chemical sensing platform, a sensing terminal 5 comprises conductive glass and a SnO₂ film formed thereon. The sensing terminal 5 is covered with an insulating material, with only the SnO₂ film exposed. The sensing terminal 5 and a field effect transistor are integrated, acting as a pH sensor.

The sensing terminal 5 is immersed in a liquid 6 in a container 17. The sensing terminal 5 is connected to a gate of a field effect transistor (FET) 8 via a conductive wire 7. Source and drain of the FET 8 are connected respectively via conductive wires 9 and 10 to a semiconductor measuring device 11 processing an electronic signal received from the MOSFET 8.

Moreover, a reference electrode 12 can also be immersed in the liquid 6 to provide stable voltage. The reference electrode is a Ag/AgCl material, also connected to the semiconductor measuring device 11 via a conductive wire 13. A plurality of heating/cooling devices 14 outside the container 17 connect to a temperature controller 15. When the temperatures of the liquid 6 increases or decreases, the temperature controller 15 directs the heating/cooling devices 14 to cool or heat the liquid 6. A thermocouple 16 connected to the temperature controller 15 detects the temperature of the liquid 6. The liquid 6, all components contacting the liquid 6, and the heating/cooling devices 14, are all placed inside the container 17. The container may be used as a light-isolating device (e.g. a dark box) to prevent influence of light on measurement.

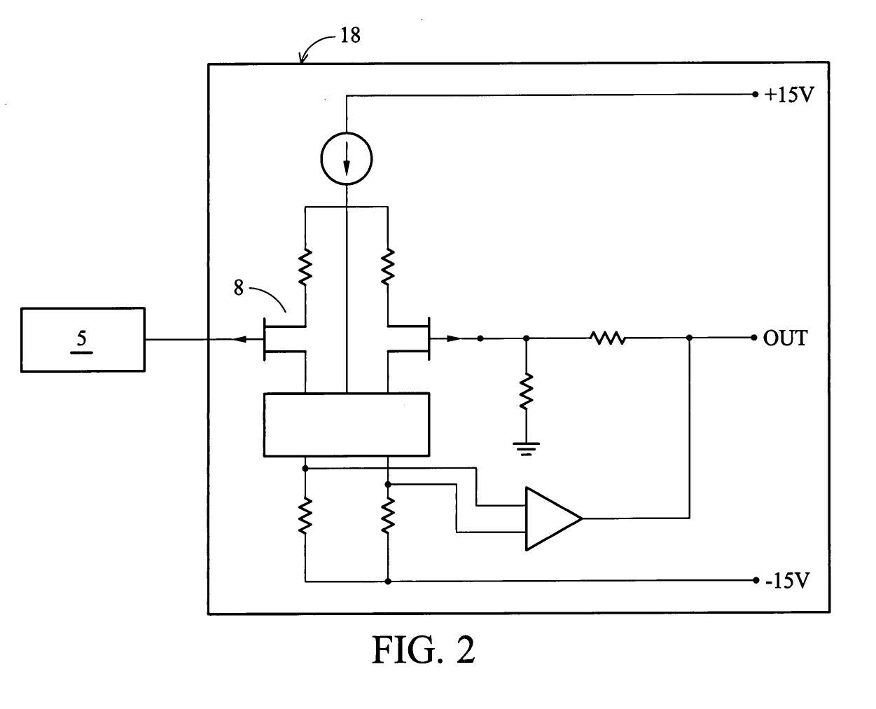

FIG. 2 is a schematic diagram of a sensing and amplifying device in accordance with an embodiment of the invention. The FET 8 in FIG. 1 can be a part of a differential amplifier 18. The sensing terminal is connected to an input with the FET 8 of the differential amplifier 18. Output signal of the sensing terminal is amplified by the differential operational amplifier 18 and transmitted to the semiconductor measuring device 11 through an output terminal OUT.

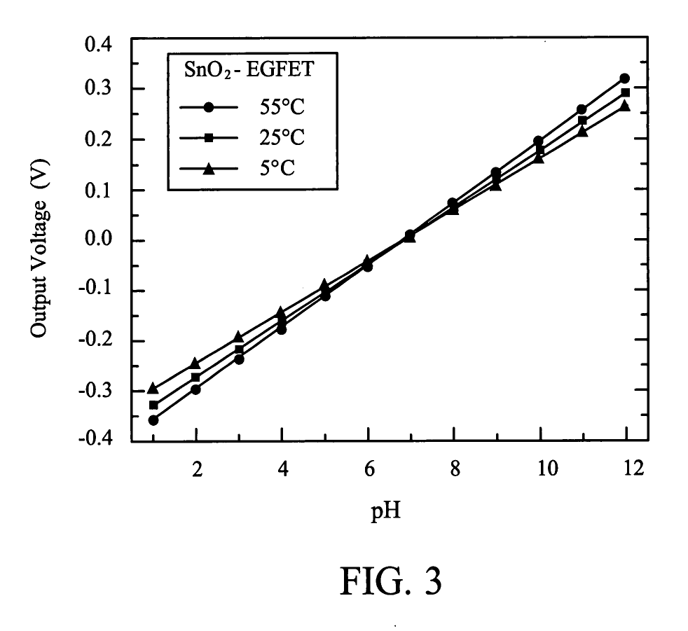

FIG. 3 shows the response relation of the sensing and amplifying device of FIG. 2 with the temperature of the liquid 6, illustrating the pH and temperature of the liquid 6 are related. The temperature of the liquid 6 contacting the metal oxide electrode is between 5 and 55° C. The pH of any liquid is a function of temperature. Voltage outputs at different temperatures all have linear relationship with pH, and the slopes of the lines are determined by the temperature of the liquid 6. As shown in FIG. 3, the average sensitivity of the EGFET 18 with a SnO₂ film is 56.88 mV/pH at 25° C., falling to 53.07 mV/pH at 5° C., and increasing to 61.15 mV/pH at 55° C.

The chemical sensing platform 100 in FIG. 1 obtains a linear relationship between the pH of liquids and the output voltage of the operational amplifier at a fixed temperature using more than two liquids of standard pH, before calculating the pH of a liquid according to output voltage of the operational amplifier at the fixed temperature when the SnO₂ contacts the liquid.

The chemical sensing platform 100 can comprise a push-button interface or remote control interface for setting measurement parameters (not shown in FIG. 1). The chemical sensing platform 100 can further comprise a display interface to display measurement results.

Table 1 is a comparison table of pH calculated by a commercial pH meter and by the sensing and amplifying device of FIG. 2 connected to an instrumentation amplifier.

pH thus can be measured accurately using the pH sensor and chemical sensing platform provided by the embodiments.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

TABLE 1

| Temperature | | |
|---|---|---|
| 15° C. | 25° C. | 35° C. |

pH meter

| | pH | | pH | | pH | |
|---|---|---|---|---|---|---|
| pH | meter | SnO₂ | meter | SnO₂ | meter | SnO₂ |
| pH1 | 0.99 | 0.98 | 1 | 0.99 | 1.02 | 1.02 |
| pH2 | 1.99 | 1.98 | 2 | 2.00 | 2.00 | 2.02 |
| pH3 | 3.00 | 3.02 | 3 | 3.01 | 2.99 | 3.00 |
| pH4 | 3.99 | 3.98 | 4 | 3.99 | 4.02 | 4.01 |
| pH5 | 5.02 | 5.02 | 5 | 5.00 | 5.00 | 5.00 |
| pH6 | 5.99 | 5.98 | 6 | 5.99 | 6.02 | 6.02 |
| pH7 | 7.04 | 7.03 | 7 | 7.01 | 6.98 | 6.99 |
| pH8 | 8.09 | 8.05 | 8 | 8.02 | 7.94 | 8.00 |
| pH9 | 9.10 | 9.10 | 9 | 9.00 | 8.93 | 9.00 |
| pH10 | 10.10 | 10.10 | 10 | 10.00 | 9.90 | 9.99 |
| pH11 | 11.20 | 11.20 | 11 | 11.10 | 10.81 | 11.00 |
| pH12 | 12.26 | 12.10 | 12 | 11.98 | 11.75 | 12.00 |

What is claimed is:

1. A pH sensor, comprising:
conductive glass;
a SnO₂ film formed on the conductive glass; and
a field effect transistor with a gate coupled to the SnO₂ film;
wherein the SnO₂ film contacts a liquid with a predetermined voltage to generate a voltage difference therebetween, the pH sensor determining pH of the liquid according to a linear relationship between channel current of the field effect transistor and the voltage difference.

2. The pH sensor of claim 1, further comprising a conductive wire with one end connecting the SnO₂ film and the other end connecting the gate of the field effect transistor; with the field effect transistor connected to the SnO₂ film via the conductive wire without immersion in the liquid.

3. The pH sensor of claim 2, further comprising an insulating material covering the conductive glass and the conductive wire, exposing the SnO₂ to contact the liquid.

4. A chemical sensing platform for detecting pH of a liquid, comprising:
a reference electrode in the liquid, providing a stable voltage; and
at least one pH sensor, comprising:
conductive glass;
a SnO₂ film formed on the conductive glass; and
a field effect transistor with a gate coupled to the SnO₂ film;
wherein the SnO₂ film contacts a liquid with a predetermined voltage to generate a voltage difference between the liquid and the SnO₂ film, the pH sensor determining pH of the liquid according to a linear relationship between channel current of the field effect transistor and the voltage difference.

5. The chemical platform of claim 4, wherein the pH sensor further comprises a conductive wire with one end connecting the SnO₂ film and the other end connecting the gate of the field effect transistor; with the field effect transistor connected to the SnO₂ film via the conductive wire without immersion in the liquid.

6. The chemical platform of claim 5, wherein the pH sensor further comprises an insulating material covering the conductive glass and the conductive wire, exposing the SnO₂ to contact the liquid.

7. The chemical platform of claim 4, further comprising a light-isolating device to accommodate the liquid and prevent influence of light on measurement.

8. The chemical platform of claim 4, further comprising a temperature control system to maintain environmental temperature.

9. The chemical platform of claim 8, wherein the temperature control system comprises:
a temperature detection device measuring the measuring environment temperature; and
a heating/cooling device adjusting the environmental temperature to a desired temperature.

10. The chemical platform of claim 4, wherein the reference electrode is a Ag/AgCl reference electrode.

11. The chemical platform of claim 4, wherein the field effect transistor is a field effect transistor of an input of an operational amplifier.

12. The chemical platform of claim 4, further obtaining a linear relationship between pH of more than two liquids of standard pH and output voltages of the operational amplifier at a fixed temperature, before calculating the pH of a liquid according to output voltage of the operational amplifier at the fixed temperature when the SnO₂ film contacts the liquid.

13. The chemical platform of claim 4, further comprising a push-button interface for users to set measurement parameters.

14. The chemical platform of claim 4, further comprising a remote control interface for users to set measurement parameters.

15. The chemical platform of claim 4, further comprising a display interface to display the measurement results.
